(19) United States
(12) Patent Application Publication
(10) Pub. No.: US 2010/0211350 A1
(43) Pub. Date: Aug. 19, 2010

(54) SPEED METER

(76) Inventors: Yung-Hung Chih, Shulin City (TW); Ching-Wen Yeh, Shulin City (TW)

Correspondence Address: Muncy, Geissler, Olds & Lowe, PLLC, 4000 Legato Road, Suite 310, FAIRFAX, VA, 22033, US

(21) Appl. No.: 12/372,487

(22) Filed: Feb. 17, 2009

(51) Int. Cl. G01P 3/00

(52) U.S. Cl. 702/142

(57) ABSTRACT

A speed meter connected to a vehicle comprises a casing provided with a liquid crystal screen, and a gravity sensor, a power source, a circuit board, and a microprocessor are provided in the casing. The microprocessor is located on the circuit board. The power source, the circuit board, the liquid crystal screen, and the gravity sensor are respectively electrically connected with each other and the gravity sensor is connected with the microprocessor. Thereby, when the vehicle is driven forward, the forward speed of the vehicle can be obtained via the calculation of the microprocessor after the gravity sensor detects the forward acceleration. The obtained forward speed can be shown on the liquid crystal screen to inform users immediately.

### TECHNICAL FIELD

The present invention relates to a speed meter and, more particularly, to a speed meter suitable for vehicles (such as bicycles, motorcycles, or three-wheelers), where the forward speed of the vehicle can be obtained via the calculation of the microprocessor after the gravity sensor detects the forward acceleration.

### BACKGROUND

Speed meters are able to detect the speed of cars, motorcycles, or other vehicles to provide recent speed to drivers or riders in order to escape potential risk resulted from driving or riding vehicles too fast. Therefore, speed meters are widely used in various vehicles, such as cars, three-wheelers, motorcycles, and bicycles.

Among various vehicles, the speed meters used in bicycles are exemplified hereinafter. Each of these speed meters mainly comprises a signal emitter, a signal receiver, a calculation unit, and a display. The signal emitter is fixed at the spoke of a wheel. The signal receiver is fixed at one side of the chain stay and connected with a microprocessor via a connecting wire. Thereby, when a drivers or rider drives or rides a vehicle and keep the wheel together with the signal emitter moving circularly, the signal receiver executes detection repeatedly and the speed of the vehicle can be obtained via the calculation of the microprocessor and shown on the display.

However, a more complicated assembly is required because the signal emitter and the signal receiver are fixed at the spoke and the chain stay, and the signals are transmitted by using a connecting wire. Thereby, it takes more time to dispose the assembly. Besides, the assembly may easily become detached from the bicycle since the signal emitter rotates with the wheel and the signal emitter and the signal receiver bear the vibration back from the ground directly.

In order to overcome above shortcomings, inventor had the motive to study and develop the present invention. After hard research and development, the inventor provides a speed meter that can be firmly disposed at vehicles, has simpler and fewer components, and can be easily disposed or detached.

### SUMMARY OF THE DISCLOSURE

An object of the present invention is to provide a speed meter that is disposed at a vehicle and has a gravity sensor for detecting the acceleration of the vehicle moving forward and a microprocessor for figure out the forward speed of the vehicle.

In order to achieve above object, the present invention provides a speed meter that is connected to a vehicle and comprises a casing provided with a liquid crystal screen and a gravity sensor. A power source and a circuit board that is electrically connected with the power source and the liquid crystal screen are provided in the casing with the liquid crystal screen. The circuit board is provided with a microprocessor thereon. The gravity sensor is provided in the casing and connected with the microprocessor. Thereby, when a vehicle moves forward, the gravity sensor can detect the acceleration of the vehicle and the forward speed of the vehicle can be obtained by the calculation of the microprocessor and shown on the liquid crystal screen.

The following detailed description, given by way of examples or embodiments, will best be understood in conjunction with the accompanying drawings.

### BRIEF DESCRIPTION OF THE DRAWINGS

FIG. 1 is a perspective view showing that an embodiment of a speed meter of the present invention is disposed at the handlebar of a vehicle.

FIG. 2 shows a circuit block diagram of the embodiment of the speed meter of the present invention.

### DETAILED DESCRIPTION

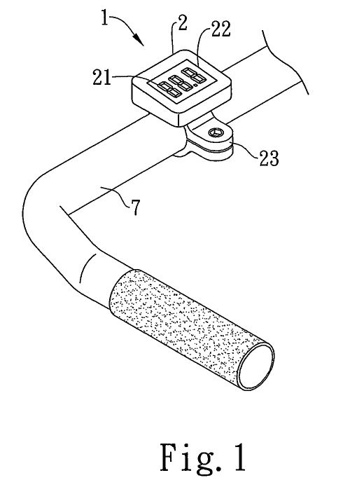

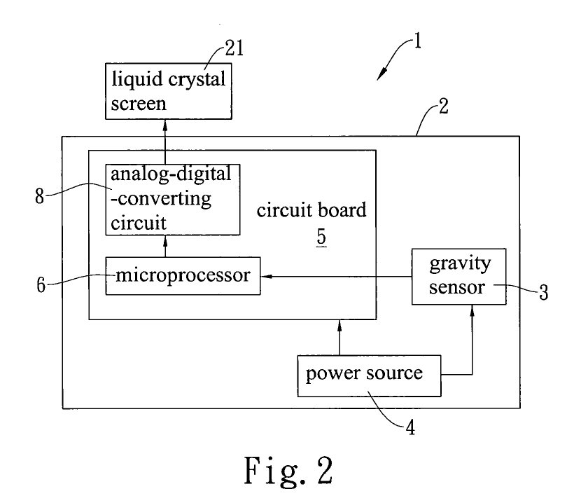

Please refer to FIGS. 1 and 2 showing a preferred embodiment of a speed meter according to the present invention. The speed meter 1 comprises a casing 2 provided with a liquid crystal screen 21, a gravity sensor 3, a power source 4, a circuit board 5, and a microprocessor 6.

The casing 2 is roughly in rectangular shape. In practice, the casing 2 also can be in cylindrical or other three-dimensional shapes. A space is formed within the casing 2 and an opening 22 is provided on the top of the casing 2 for locating a liquid crystal screen 21. A connector 23 is provided on the bottom of the casing 2 for connecting the casing 2 to the handlebar 7 of a vehicle, such as a bicycle, motorcycle, or a three-wheeler.

The gravity sensor 3, power source 4, circuit board 5, and microprocessor 6 are respectively positioned in the space of the casing 2. The power source 4 is at least a dry battery for providing direct current to the circuit board 5 and the gravity sensor 3. Besides, the power source also can be at least a lithium battery. The circuit board 5 is electrically connected with the liquid crystal screen 21. The microprocessor 6 is fixed on the circuit board 5 and connected with the gravity sensor 3. The gravity sensor 3 mainly comprises fixed and movable electrode plates. The structure and action mechanism of the electrode plates are well known and will not be described in details hereinafter.

When a vehicle moves forward, the movable electrode plate of the gravity sensor 3 will move relative to the fixed electrode plate along X-axis and Y-axis, and the space change between any two electrode plates will occur. Accordingly, the capacitance value will vary with the space change, and consequently the voltage value will change correspondingly to be converted to electric signals. The forward speed of the vehicle can be obtained after these electric signals are calculated by the microprocessor 6. The speed of a vehicle can be figured out based on the forward acceleration of the vehicle and shown on the liquid crystal screen 21 after the electric signals are converted into digital signals via an analog-digital-converting circuit 8 provided on the circuit board 5.

Therefore, the present invention has following advantages:

1. According to the present invention, the number of components required for the speed meter can be reduced effectively and the speed meter can be conveniently attached to or detached from vehicles by drivers or riders themselves.

2. The speed meter according to the present invention is disposed at the handlebar of a vehicle and it is not necessary to fix a signal emitter at the spoke of a wheel and a signal receiver at one side of the chain stay. Thereby, the speed meter will not become detached from the vehicle after long-term use and the lifetime thereof is thus lengthened.

As disclosed in the above description and attached drawings, the present invention can provide a speed meter having simple structure and can be conveniently and firmly disposed at a vehicle. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A speed meter, connected to a vehicle, comprising:
a casing, provided with a liquid crystal screen and having a power source and a circuit board that is electrically connected with the power source and the liquid crystal screen, where the circuit board is provided with a microprocessor thereon; and
a gravity sensor, provided in the casing and connected with the microprocessor for detecting the forward acceleration of the vehicle and then the forward speed is obtained by the calculation of the microprocessor and shown on the liquid crystal screen.

2. The speed meter as claimed in claim 1, wherein the power source is at least a lithium battery or at least a dry battery.

3. The speed meter as claimed in claim 1, wherein after the gravity sensor detects the forward acceleration values of the vehicle along X-axis and Y-axis, these values are calculated by the microprocessor to obtain the forward speed of the vehicle.
